(19) United States
(12) Patent Application Publication
(10) Pub. No.: US 2011/0078750 A1
(43) Pub. Date: Mar. 31, 2011

(54) TRICKPLAY IN MEDIA FILE

(75) Inventors: Raymond Tam, Fremond, CA (US); Saldy Antony, San Jose, CA (US)

(73) Assignee: 2WIRE, San Jose, CA (US)

(21) Appl. No.: 12/569,878

(22) Filed: Sep. 29, 2009

(51) Int. Cl. H04N 5/91; H04N 7/173; H04N 5/783

(52) U.S. Cl. 725/88; 725/116; 725/109; 386/E05.003; 386/343

(57) ABSTRACT

A method and apparatus to perform trickplay processing by a client computing system during the playback of a downloaded media file, regardless of how far along the download has progressed. The client computing system determines whether it is configured to play the media file in trickplay mode and identifies, by a keyframe identifier module, a first keyframe in the media file. The keyframe is retrieved using index information contained within the media file and displayed on a display as part of the trickplay processing. If the client computing system is still in trickplay mode, the next keyframe is identified and the process repeats. Once the client computing system has exited trickplay mode, the keyframe identifier module identifies the closest keyframe to the current position in the media file and begins normal playback of the media file at the location of the closest keyframe.

### TECHNICAL FIELD

Embodiments of the present application relate to the field of playing a media file and, in particular, to performing trickplay in the media file.

### BACKGROUND

Many home media entertainment systems include a set-top box that is configured to play media files stored on a server at a remote location. For example, an individual may have a broadband entertainment television box in his home that is connected through a network to the servers at the service provider's office. Many of these set-top boxes are configured to offer a service, such as for example, a media-on-demand service. In a media-on-demand service, the user is able to select a particular piece of media (e.g., a movie) from a media catalog stored on the service provider's servers using a set-top-box in their home. The set-top-box downloads the requested media file from the servers and plays the media file on the user's television or other playback device. A similar service may be provided for music files, digital photos, or other media types.

Certain set-top-boxes are configured to allow trickplay functionality during the playback of the media files. Trickplay functions may include, for example, fast-forwarding, rewinding, or other playback functions. In conventional systems, when a user wishes to use a trickplay function, the user must wait until a certain amount of the media file is downloaded from the server before the trickplay functionality is enabled. Even if trickplay is enabled after a short period of time of downloading the media file, the trickplay is confined to only the portion of the media file that has been downloaded during that period of time. If the user wishes to use trickplay to access a portion of the media file near the end, the user will have to wait until the download reaches the specific portion of the media file.

Certain systems attempt to solve this problem by including trickplay intelligence on the media server to enable trickplay regardless of how far along the download of the media file has progressed. Having trickplay intelligence only on the server side, however, limits the trickplay functionality of the client set-top-box. In such a system, the client can only perform trickplay on a media file from a server having the trickplay processing capability. If the user wishes to download and play media from a standard media server, such as a HyperText Transfer Protocol (HTTP) server, the limitations on trickplay functionality discussed above persist.

### BRIEF DESCRIPTION OF THE DRAWINGS

The present disclosure is illustrated by way of example, and not by way of limitation, in the figures of the accompanying drawings.

FIG. 1 is a block diagram illustrating a system for providing downloadable media from a server to a client computing system according to an embodiment.

FIG. 2 is a flow chart illustrating a client-based trickplay method according to an embodiment.

FIG. 3 is a block diagram illustrating the media payload of a media file according to an embodiment.

FIG. 4 is a block diagram illustrating a system for providing downloadable media from a server to a client computing system according to an embodiment.

FIG. 5 is a block diagram illustrating a media file structure according to an embodiment.

### DETAILED DESCRIPTION

The following description sets forth numerous specific details such as examples of specific systems, components, methods, and so forth, in order to provide a good understanding of several embodiments of the present invention. It will be apparent to one skilled in the art, however, that at least some embodiments of the present invention may be practiced without these specific details. In other instances, well-known components or methods are not described in detail or are presented in simple block diagram format in order to avoid unnecessarily obscuring the present invention. Thus, the specific details set forth are merely exemplary. Particular implementations may vary from these exemplary details and still be contemplated to be within the scope of the present invention.

Embodiments of a method and apparatus are described to perform trickplay processing on a downloaded media file, at a client computing system, during the playback of the media file, regardless of how far along the download has progressed. The trickplay processing is performed on the media file by the client computing system without any trickplay processing being performed by the server before the media file is received from the server. In one embodiment, the client computing system determines whether the client computing system is configured to play the media file in a trickplay mode. A client computing system is in a trickplay mode if a user has initiated a trickplay command during playback of the media file. A trickplay command may include any manipulation or control of the presentation of the media file during playback or an attempt to play the media file non-sequentially. Examples of trickplay commands may include fast-forwarding, rewinding, pausing, seeking, skipping, replaying, or other playback functions. Generally, trickplay may include any variation from playback of the media file at a normal speed, aside from starting or stopping playback. If the user has initiated a trickplay command, the client computing system enters the trickplay mode and identifies, at a keyframe identifier module, a first keyframe in the media file. A keyframe (or intraframe) is a frame of data that is decoded independently from other frames in the file. In a keyframe, no data is copied from either a previous or subsequent frame in the data stream. Keyframes typically occur at regular intervals throughout the media file (e.g., every 1 second or 500 milliseconds). The keyframe is retrieved using index information contained within the media file and displayed on a display as part of the trickplay processing. If the client computing system is still in trickplay mode, the next keyframe is identified and the process repeats. Once the client computing system has exited trickplay mode, the keyframe identifier module identifies the closest keyframe to the current position in the media file and begins normal sequential playback of the media file at the location of the closest keyframe.

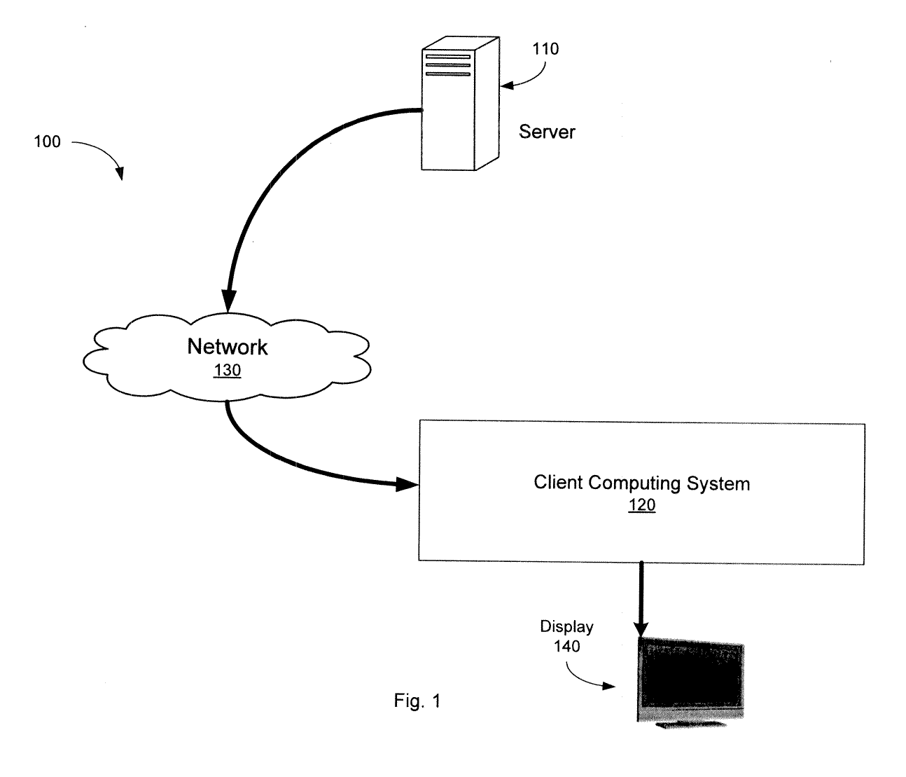

FIG. 1 is a block diagram illustrating a system 100 for providing downloadable media from a server 110 to a client computing system 120 according to an embodiment. Server 110 may be any type of server such as for example, a digital media server, a HyperText Transfer Protocol (HTTP) server, or other storage device. Client computing system 120 may be any computing system capable of receiving downloaded or streamed media files from server 110, such as for example, a set-top broadband entertainment service box, personal computer, or other computing system. In one embodiment, server 110 and client computing system 120 are connected over network 130. Network 130 may be any communications network, such as for example, a local area network (LAN), a wide area network (WAN) such as the internet, or other similar communications system.

In one embodiment, server 110 is located at a remote location, such as for example, at the office of a broadband entertainment service provider, while client computing system 120 is located in the home of a subscriber to the broadband entertainment service. In another embodiment, the server 110 and client computing system 120 are located at the same location. Media files stored on server 110 are downloaded or streamed to client computing system 120 for playback and display on a display, such as display 140. This arrangement allows a user of client computing system 120 to access a wide variety of media files without requiring large amounts of storage to be contained locally within client computing system 120. In another embodiment, there are a plurality of client computing systems that all access the media files stored on a single server 110. In yet another embodiment, client computing system 120 accesses media files stored on a plurality of servers.

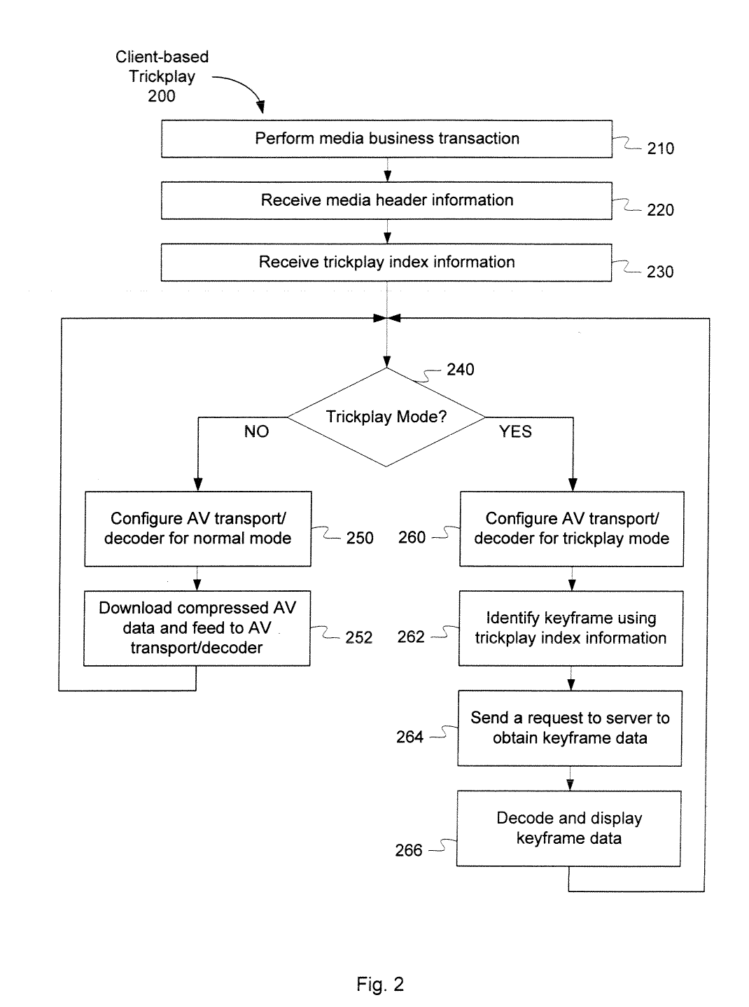

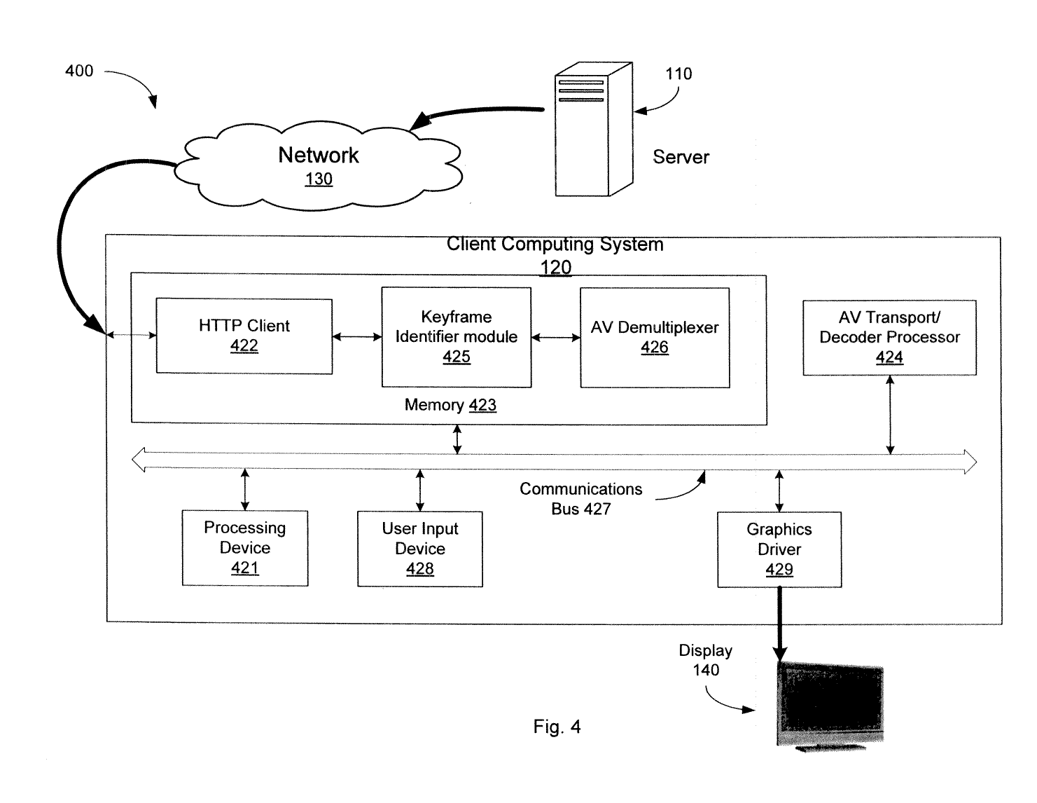

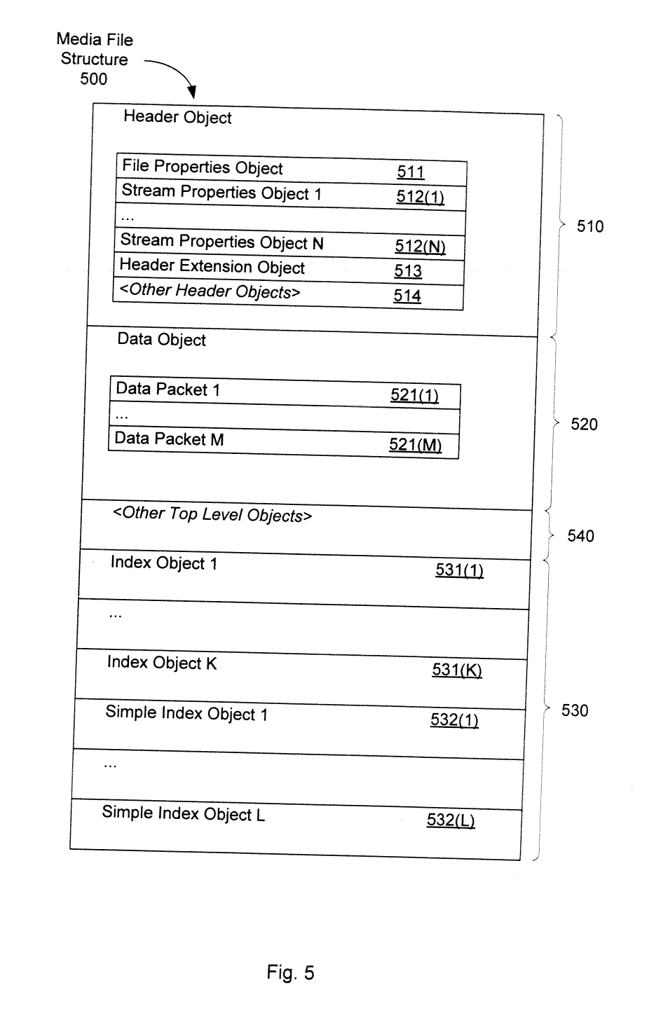

FIG. 2 is a flow chart illustrating one embodiment of client-based trickplay method 200. The process 200 may be performed by processing logic that comprises hardware, firmware, software, or a combination thereof. In one embodiment, process 200 is performed at client computing system 120 by a processing device, such as processing device 421 described below with respect to FIG. 4. The trickplay method 200 described herein may be used to perform trickplay processing during playback of a media file, such as media file 500 shown in FIG. 5, regardless of how far along the download of media file 500 has progressed.

Referring to FIG. 2, client-based trickplay method 200 performs trickplay processing operations at the client computing system, such as client computing system 120, to enable trickplay on a media file, regardless of what server the media file is received from. At block 210, method 200 performs a media business transaction. In one embodiment, a user interacts with the client computing system, which in turn, interacts with a media server, such as server 110 of the media service provider to authorize the media download. A fee associated with the media download may be incurred. As a result of the business transaction, the client computing system 120 acquires an identifier, such as a Uniform Resource Locator (URL), of the server and receives permission to download the media file 500, as shown in FIG. 5.

At block 220, method 200 downloads the media file header information. As discussed further below with regard to FIG. 5, the header information may include header object 510, which provides a known sequence of bytes at the beginning of the media file 500 and contains all the information that is needed to properly interpret the payload data of the media file. At block 230, method 200 downloads the trickplay index information. In one embodiment, the trickplay index information includes index object 530. The index object 530 may contain an offset in the media file for the start of each keyframe as well as the length of each keyframe.

At block 240, method 200 determines whether the client computing system is configured to play the media file in a trickplay mode. In one embodiment, the client computing system will be in trickplay mode if a user of the client computing system initiates a trickplay command, such as by fast-forwarding or rewinding the media file. If trickplay has not been enabled, method 200 continues to block 250. At block 250, method 200 configures the AV (audio/visual) transport/decoder, such as AV transport/decoder processor 424, as shown in FIG. 4, for normal playback speed. At block 252, method 200 downloads the compressed AV data and feeds the data to the AV transport/decoder for playback. In normal playback, the data frames of media file 500 are downloaded by HTTP client 422, as shown in FIG. 4, decoded by AV transport/decoder processor 424 and displayed on display 140, sequentially. In one embodiment, the playback mode determination is made by processing device 421.

If at block 240, method 200 determines that trickplay has been enabled, method 200 continues to block 260. At block 260, method 200 configures the AV transport/decoder 424 for trickplay mode. Trickplay mode enables the client computing system 120 to perform trickplay processing on data in the media file. As discussed above, in the normal playback mode, the client computing system 120 receives, decodes and displays the data in the media file sequentially. Upon switching to the trickplay mode, the client computing system 120 uses the data in the media file for another function. After trickplay processing is performed, client computing system is able to use the keyframes in the media file to locate a specific position within the media file without proceeding through the file sequentially. Thus, trickplay processing transforms the media file into data that can respond to trickplay commands, such as fast-forwarding or rewinding of the media file.

At block 262, method 200 uses the trickplay information index object 530 to identify a keyframe in the media file. The keyframe is identified by retrieving the offset in the media file and size of the closest keyframe using a current play position in the media file as a key to the trickplay index. In one embodiment, where the trickplay command is fast-forwarding, method 200 will locate the next subsequent keyframe in the media file in relation to the current playback position. In another embodiment, where the trickplay command is rewinding, method 200 will locate the previous keyframe.

At block 264, method 200 issues a request with the correct range to obtain the keyframe data from the server 110. In one embodiment, the request is an HTTP “GET” command. The request includes the offset in the media file and size of the keyframe identified at block 262. At block 266, method 200 receives the requested keyframe and presents the compressed keyframe data to the AV transport/decoder processor 424. AV transport/decoder processor 424 decodes (uncompresses) the keyframe data and displays the keyframe data on display 140.

After displaying the keyframe at block 266, method 200 returns to block 240 to determine whether the client computing system 120 is still in the trickplay mode. Client computing system 120 will still be in trickplay mode if the user has not entered input, such as for example, pushing the play button on a remote control, to cause client computing system 120 to return to normal playback mode. If at block 240, method 200 determines that the client computing system 120 is still in trickplay mode, the actions of blocks 260-266 are repeated for either the subsequent or previous keyframe in the media file 500. If at block 240, method 200 determines that the client computing system 120 is no longer in trickplay mode, method 200 continues to blocks 250 and 252 to resume sequential playback from the location in the media file 500 of the closest keyframe. Method 200 identifies the closest keyframe to the current play position and plays the media file at the location of that keyframe.

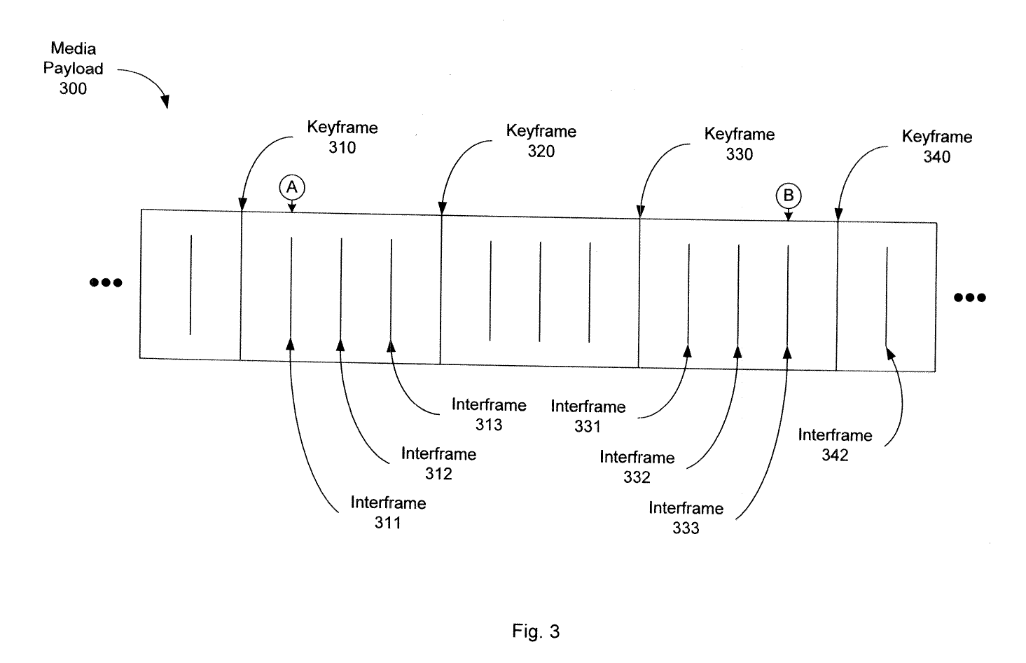

FIG. 3 is a block diagram illustrating the media payload 300 of a media file, such as media file 500 according to an embodiment. The media payload 300 includes the actual data representing the audio and video portions of the media file 500. In one embodiment, this data is grouped in a series of one or more frames. The frames may be packets of data or other groupings of the data. The frames include keyframes (intraframes) 310, 320, 330, 340, and interframes 311, 312, 313, 331, 332, 333, 341. As discussed above, keyframes are frames of data which are decoded independently from other frames in the file, as no data is copied from either a previous or subsequent frame in the data stream. This is in contrast to interframes, where data is copied from one adjacent frame to another. FIG. 3 illustrates one example of a section of media payload 300 where there are four keyframes with three interframes between each keyframe. In other embodiments, there may be any number of keyframes with any number of interframes between each keyframe.

In the example of FIG. 3, if the media file is played in a normal playback mode, playback progresses sequentially from left to right. Each frame is displayed in order from 310, 311, 312, 313, 320, and so on. In this example, the media file 300 is in normal playback mode and has progressed to point A. At point A, a user enters an input command through user input device 428, as shown in FIG. 4, in this case fast-forward, which causes the client computing system 120 to enter trickplay mode. As in block 260 of method 200, the AV transport/decoder processor 424 is configured for trickplay mode. Keyframe identifier module 425 uses index object 530 to locate the offset and length of the next keyframe, as described in block 264. In this case, since the trickplay command is fast-forward, the next keyframe after point A is located (i.e., keyframe 320). Keyframe 320 is requested from server 110 at block 264 and sent to AV transport/decoder processor 424 and displayed on display 140 at block 266. In this embodiment, interframes 312 and 313 are not downloaded from server 110.

After keyframe 320 has been downloaded, decoded and displayed, client computing system 120 determines whether it is still in trickplay mode. If the user has not caused client computing system 120 to return to normal playback mode, the above steps are repeated for keyframe 330, bypassing any interframes between keyframes 320 and 330. If the user causes client computing system 120 to exit trickplay mode at point B, the change is detected at block 240 and the process continues with normal playback at blocks 250 and 252. In this case, beginning with the next keyframe, keyframe 340, the subsequent frames (i.e., interframe 341) will be downloaded, decoded and displayed sequentially until the end of the media payload 300 or until the user initiates another trickplay command.

FIG. 4 is a block diagram illustrating the system 400 according to an embodiment. The system 400 may be similar to the system 100 discussed above with respect to FIG. 1. In one embodiment, client computing system 120 includes processing device 421, memory 423, and AV transport/decoder processor 424. Processing device 421 represents one or more general-purpose processing devices such as a microprocessor, central processing unit (CPU), or the like. Processing device 421 may also be one or more special-purpose processing devices such as an application specific integrated circuit (ASIC), a field programmable gate array (FPGA), a digital signal processor (DSP), network processor, or the like. Processing device 421 is configured to execute the trickplay processing operations discussed herein at client computing system 120.

Memory 423 of client computing system 120 may include a main memory, such as for example, read-only memory (ROM), flash memory, dynamic random access memory (DRAM) such as synchronous DRAM (SDRAM) or Rambus DRAM (RDRAM), or other memory. In one embodiment memory 423 includes HTTP client 422, keyframe identifier module 425, and audio/visual (AV) demultiplexer 426.

In one embodiment, HTTP client 422 is a software plug-in that functions as a user agent. The user agent works in conjunction with server 110 to request and receive media files. In one embodiment HTTP client 422 initiates a request by establishing a Transmission Control Protocol (TCP) connection to a particular port on a host. An HTTP server, such as service device 110, listening on that port waits for the client 422 to send a request message. Upon receiving the request message, the server 110 sends back a status line, such as for example “HTTP/1.1 200 OK” and a message of its own, the body of which may be the requested media file, an error message, or some other information. In one embodiment, the HTTP client 422 is the plug-in “souphttpsrc” from the GStreamer open source multimedia framework. In other embodiments, the client 422 may be some other user agent that supports additional protocols, such as for example, HTTP Secure (HTTPS).

Keyframe identifier module 425 locates keyframes within the received media file. Keyframe identifier module 425 locates the keyframes in the media file using index information contained within the media file. In one embodiment, the index information, which contains an offset and length of each keyframe, is used as a lookup table by keyframe identifier module 425 to locate the keyframes in the media file. The index information will be described further below.

Demultiplexer 426 is a software module, controlled by processing device 421, which separates the audio and video streams from the received media file. The separate streams are then provided to AV transport/decoder processor 424. In one embodiment, the demultiplexer 426 is implemented in software, however in other embodiments, a hardware demultiplexer is used.

AV Transport/Decoder processor 424 decodes the received audio and video streams. AV transport/decoder processor 424 can uncompress the received data which may be compressed using a standard, such as for example, VC-1 or H.264. In one embodiment, AV transport/decoder processor 424 is System-on-Chip (SoC) solution, such as the Broadcom BCM7405. The AV transport/decoder processor 424 may include a CPU, graphics processing, a data transport processor, and video and audio decoders, among other features.

In one embodiment, the components of client computing system 120 are coupled together via communications bus 427. Bus 427 represents the interconnection between system components or blocks. Bus 427 may be one or more communications buses, or alternatively may represent one or more single signal lines.

In one embodiment, client computing system 120 further includes a user input device 428. User input device 428 may also be coupled to communications bus 427. User input device 428 may include an infrared light sensor configured to received infrared signals from a remote control device. User input device 428 may also include one or more control buttons for controlling the operation of client computing system 120. Additionally, user input device 428 may include a keyboard and/or a cursor control device, such as a computer mouse, for inputting information to the client computing system 120. A user of client computing system 120 can control operations of the client computing system 120 through user input device 428. For example, the user may perform a media business transaction to initiate the downloading of a media file from server 110. The user may initiate playback of the downloaded media file and perform trickplay functions, such as fast-forwarding or rewinding the media file, through user input device 428.

Display 140 is configured to display the media files download from server 110 to client computing system 120. Display 140 may include a liquid crystal display (LCD), a cathode ray tube (CRT) display, or other display connected to the client computing system 120 through a graphics driver 129, which may include a graphics port and/or graphics chipset.

FIG. 5 is a block diagram illustrating a media file 500 structure according to an embodiment. The media file 500 may be downloaded from a server, such as server 110, to a client computing system, such as client computing system 120, for playback and viewing. In one embodiment a media file, such as media file 500 includes at least three types of objects. The media file 500 includes a header object 510, a data object 520 and one or more index objects 530. Header object 510 is the first object in the media file 500 and designates the beginning of the media file 500. Data object 520 follows header object 510 and contains the media payload. Index objects 530 are the last objects in the media file 500 and provide access to the media file 500 at random points (e.g., at keyframes). In certain embodiments, media file 500 may optionally include other top-level objects 540.

Header object 510 provides a known sequence of bytes at the beginning of the media file 500 that contains all the information that is needed to properly interpret the data from data object 520. In one embodiment, header object 510 also contains metadata for the media file 500, such as bibliographic information.

In one embodiment, header object 510 also contains other lower-level objects. Header object 510 may include any number of standard objects including, but not limited to those described herein. In this embodiment, header object 510 includes file properties object 511. File properties object 511 contains global file attributes for media file 500. The global file attributes define the global characteristics of the combined digital media streams found within data object 520. In this embodiment, header object 510 further includes one or more stream properties objects 512, such as stream properties objects 512(1)-512(N). Stream properties objects 512 define a digital media stream and its characteristics, how a digital media stream within data object 520 is interpreted, as well as the specific format of the data packet(s) within data object 520. In this embodiment, header object 510 also includes header extension object 513. Header extension object 513 allows additional functionality to be added to the media file 500 while maintaining backward compatibility. Header extension object 513 may be a container configured to hold additional extended header objects.

In another embodiment, header object 510 includes additional header objects 514 that may include, for example: a content description object, which contains bibliographic information; a script command object, which contains commands that can be executed on a playback timeline; and a marker object, which provides named jump points within the media file 500. In alternative embodiments, header object 510 may include more or fewer lower-level objects and the lower-level objects may appear in any order within header object 510.

Data Object 520 contains all of the digital media data for the media file 500. The data is stored in the form of data packets 521, such as data packets 521(1)-521(M). Data packets 521 are stored with a fixed length and each data packet 521 may contain data for one or more digital media streams. In one embodiment, data packets 521 are ordered within data object 520 based on the time they are to be delivered. In other embodiments, data packets 521 are ordered in some other format. A data packet 521 may contain interleaved data from several digital media streams. This data may consist of entire objects from one or more streams, or alternatively, it may consist of partial objects.

In general, media types logically consist of sub-elements that are referred to as media objects. What a media object happens to be in a given digital media stream is entirely stream-dependent (for example, a media object may be a frame within a video stream). In one embodiment, a data packet 521 is a conveniently sized grouping of complete or fragmented media objects from one or more digital media streams.

In one embodiment, data packet 521 begins with error correction data. This is signaled by the high order bit (Error Correction Present bit) of the first byte of the data packet being set. If this bit isn't set, the data packet starts with the payload data. If any error correction data is present, payload parsing information follows it. The actual digital media data follows the payload parsing information. This data can contain one or several payloads of data. Following the payload data, the data packet 521 may contain padding data.

Index objects 530 may include one or both of two types of index objects. The types of index objects include regular index objects 531, such as regular index objects 531(1)-531(K) and simple index objects 532, such as simple index objects 532(1)-532(L).

Regular index objects 531 supply the indexing information for the media file 500 that contains more than just a plain script-audio-video combination. It may include stream-specific indexing information based on an adjustable index entry time interval. The index is designed to be broken into blocks to facilitate storage that is more space-efficient by using 32-bit offsets relative to a 64-bit base. That is, each index block has a full 64-bit offset in the block header that is added to the 32-bit offsets found in each index entry. If a file is larger than 2³² bytes, then multiple index blocks can be used to fully index the entire large file while still keeping index entry offsets at 32 bits.

In one embodiment, indices into a regular index object 531 are in terms of presentation times. A corresponding offset field value of the index entry is a byte offset that, when combined with a block position value, indicates the starting location in bytes of a data packet 521 relative to the start of the first data packet in the media file 500.

In one embodiment, an offset value of 0xFFFFFFFF is used to indicate an invalid offset value. Invalid offsets signify that this particular index entry does not identify a valid indexible point. Invalid offsets may occur for the initial index entries of a digital media stream whose first data packet has a non-zero send time. Invalid offsets may also occur in the case where a digital media stream has a large gap in the presentation time of successive objects.

Regular index objects 531 may also include media object index objects, and/or timecode index objects, whose formats are similar to the index objects discussed above. A media object index object is a frame-based index that facilitates seeking by frame. A timecode index object facilitates seeking by timecode in content that contains timecodes.

Simple index objects 532 contain a time-based index of the video data in the media file 500. The time interval between index entries is constant and is stored in the simple index objects 532. For each video stream in the media file 500, there is one instance of a simple index object 532. The order in which those instances appear in the media file 500 may be significant. The order of the simple index objects 532 should be identical to the order of the video streams based on their stream numbers.

In one embodiment, index entries in the simple index objects 532 are in terms of presentation times. A corresponding packet number field value of the index entry indicates the packet number of the data packet 521 with the closest past keyframe. For video streams that contain both keyframes and non-keyframes, the packet number field may point to the closest past keyframe.

Certain embodiments described herein may be implemented as a computer program product that may include instructions stored on a machine-readable medium. These instructions may be used to program a general-purpose or special-purpose processor to perform the described operations. A machine-readable medium includes any mechanism for storing or transmitting information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or another type of medium suitable for storing electronic instructions.

Additionally, some embodiments may be practiced in distributed computing environments where the machine-readable medium is stored on and/or executed by more than one computer system. In addition, the information transferred between computer systems may either be pulled or pushed across the communication medium connecting the computer systems.

Although the operations of the method(s) herein are shown and described in a particular order, the order of the operations of each method may be altered so that certain operations may be performed in an inverse order or so that certain operation may be performed, at least in part, concurrently with other operations. In another embodiment, instructions or sub-operations of distinct operations may be in an intermittent and/or alternating manner.

What is claimed is:

1. A method, implemented by a client computing system programmed to perform the following, comprising:
receiving a media file from a server at the client computing system; and
performing, by the client computing system, trickplay processing on the media file.

2. The method of claim 1, wherein trickplay processing is performed on the media file by the client computing system without any trickplay processing being performed by the server before the media file is received from the server.

3. The method of claim 2, further comprising:
determining whether the client computing system is configured to play the media file in a trickplay mode, wherein performing trickplay processing comprises identifying, by a keyframe identifier module of the client computing system, a first keyframe in the media file, in response to the client computing system being in the trickplay mode.

4. The method of claim 3, wherein the client computing system is in a trickplay mode when the client computing system receives a trickplay command.

5. The method of claim 4, wherein the trickplay command comprises one of fast forwarding and rewinding the media file.

6. The method of claim 3, wherein a keyframe comprises a portion of the media file that is decoded independently from any other frame in the media file.

7. The method of claim 3, wherein identifying the first keyframe comprises determining an offset in the media file and a size of the first keyframe from a trickplay index in the media file.

8. The method of claim 7, further comprising:
using a current play position in the media file as a key to the trickplay index.

9. The method of claim 3, further comprising:
sending a request to the server for data in the media file corresponding to the first keyframe.

10. The method of claim 9, further comprising:
decoding the first keyframe by an audio/visual transport/decoder processor in the client computing system; and
displaying the first keyframe on a display coupled to the client computing system.

11. The method of claim 10, further comprising:
determining whether the client computing system is configured to play the media file in a normal mode;
identifying a second keyframe in the media file in response to the client computing system being in the normal mode; and
playing the media file at a location corresponding to the second keyframe.

12. The method of claim 11, further comprising:
identifying a third keyframe in the media file in response to the client computing system not being in the normal mode;
receiving the third keyframe from the server;
decoding the third keyframe by the audio/visual transport/decoder processor in the client computing system; and
displaying the third keyframe on the display.

13. An apparatus, comprising:
a processing device; and
a memory coupled to the processing device, the memory storing instructions executable by the processing device for:
a HyperText Transfer Protocol (HTTP) client module to receive a media file from a server; and
a keyframe identifier module, coupled to the HTTP client module, to identify a first keyframe in the media file in response to the apparatus being in a trickplay mode.

14. The apparatus of claim 13, the memory further storing instructions for:
an audio/visual (AV) de-multiplexer module, coupled to the keyframe identifier module, configured to separate audio and visual components of the media file.

15. The apparatus of claim 13, further comprising:
an AV transport/decoder processor, coupled to the memory, to decode the first keyframe.

16. The apparatus of claim 13, further comprising:
a user input device, coupled to the processing device.

17. The apparatus of claim 13, further comprising:
a display, coupled to the memory, to display the first keyframe.

18. The apparatus of claim 13, wherein a keyframe comprises a portion of the media file that is decoded independently from any other frame in the media file.

19. The apparatus of claim 18, wherein identifying the first keyframe comprises determining an offset in the media file and a size of the first keyframe from a trickplay index in the media file.

20. The apparatus of claim 13, wherein the apparatus is in a trickplay mode when the apparatus receives a trickplay command.

21. The apparatus of claim 20, wherein the trickplay command comprises one of fast forwarding and rewinding the media file.

22. An apparatus, comprising:
means for receiving a media file at a client computing system from a server; and
means for performing, by the client computing system, trickplay processing on the media file.

23. The apparatus of claim 22, wherein trickplay processing is performed on the media file by the client computing system without any trickplay processing being performed by the server before the media file is received from the server.

24. The apparatus of claim 23, wherein the means for performing comprises:
means for determining whether the client computing system is configured to play the media file in a trickplay mode; and
means for identifying, by a keyframe identifier module of the client computing system, a first keyframe in the media file in response to the client computing system being in the trickplay mode.

25. A computer readable storage medium including instructions that, when executed by a computer system, cause the computer system to perform a set of operations comprising:
receiving a media file from a server at a client computing system; and
performing, by the client computing system, trickplay processing on the media file.

26. The computer readable storage medium of claim 25, wherein trickplay processing is performed on the media file by the client computing system without any trickplay processing being performed by the server before the media file is received from the server.

27. The computer readable storage medium of claim 26, wherein the operations further comprise:
determining whether the client computing system is configured to play the media file in a trickplay mode, wherein performing trickplay processing comprises identifying, by a keyframe identifier module of the client computing system, a first keyframe in the media file, in response to the client computing system being in the trickplay mode.
